(19) United States
(12) Patent Application Publication
(10) Pub. No.: US 2006/0153945 A1
(43) Pub. Date: Jul. 13, 2006

(54) Valve stem having a reverse taper

(75) Inventors: Paul R. Blais, South Burlington, VT (US); Abdeslam Bouti, Swanton, VT (US); Nicholas W. Semiuck, Oakville (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/035,165

(22) Filed: Jan. 13, 2005

(51) Int. Cl. B29C 45/20

(52) U.S. Cl. 425/568

(57) ABSTRACT

A valve stem has a reverse taper thereon used in an injection nozzle for a hot runner system. The valve stem is moved downward into a closed position, such that a valve stem tip plugs or blocks an opening in a gate area, thereby precluding molten plastic from exiting the injection nozzle. The valve stem is moved upward into an open position, thereby allowing molten plastic to flow from the injection nozzle. In the open position, the reverse taper seals a clearance between the valve stem and either a manifold bushing or valve bushing, thereby precluding stem leakage or weepage. The reverse taper has a diameter which is larger than an internal diameter of internal passage of the valve bushing or manifold bushing. The valve stem also includes a headless end.

### BACKGROUND OF THE INVENTION

1. Technical Field of the Invention

The present invention relates to injection molding and more particularly, to a valve stem having a reverse taper thereon used in an injection nozzle for a hot runner system, wherein the reverse taper seals a clearance between a manifold bushing or valve bushing, and the valve stem when the valve stem is moved into an up or open position and under injection pressure, thereby precluding stem leakage or weepage.

2. Description of the Related Art

Generally, there are two types of gating arrangements used in hot runner systems that are known to those having ordinary skill in the art. The first type of gating arrangement is a thermal gate. In a thermal gate arrangement, molten plastic is forced through the hot runner system under pressure and injected through an injection nozzle into a cavity of a mold via the mold opening or gate. When the mold cavity is filled, the pressure to the hot runner system is terminated. The molten plastic remaining in the hot runner system is maintained in a molten or liquid state due to the various heating elements in the hot runner system. However, the plastic in the gate area solidifies because the surrounding area is not sufficiently heated to maintain the liquid or molten state. As a result, this solidification acts as a plug in the gate area precluding molten plastic from leaking from the nozzle of the hot runner system. During the next injection cycle, molten plastic is forced into the mold cavity at a pressure and temperature sufficient to force the plastic plug that formed at the gate area into the mold cavity. One of the problems with thermal gates is the difficulty creating the solidification or plug in the gate area. Another problem with thermal gates is improper gate vestiges.

Because of the problems and disadvantages with the thermal gates, mechanical gates, such as valve gates, are often utilized. In a valve gate arrangement, a valve stem extends in and approximately parallel or coaxial with a longitudinal axis of the flow channel of the injection nozzle, and the flow channel or internal passage of the manifold or valve bushing. A cylinder actuates or moves the valve stem up and down in the vertical direction into an open and closed position, respectively. When the pressure to the hot runner system is terminated, the cylinder moves the valve stem downward or into the closed position. The tip of the valve stem plugs the opening in the gate area of the mold cavity. In the down or closed position, the valve stem precludes molten plastic from entering the mold cavity. During the next injection cycle, the cylinder moves the valve stem up or into the open position, and pressure is applied to the hot runner system to force molten plastic through the flow channels. This allows molten plastic to be forced through the injection nozzle of the hot runner system into the mold cavity via the mold opening or gate.

The major problem with the devices known in the prior art is leakage or weepage of molten plastic in clearance areas between the valve stem, and the manifold bushing or valve bushing when the valve stem is in the up or open position. Because the valve stem moves up and down in the flow channel of the manifold bushing or valve bushing, there needs to be clearance between the parts, and the clearance between the valve stem and the manifold bushing or valve bushing needs to be sealed. Unfortunately, the devices known in the prior art do not effectively seal the clearance area between the valve stem and the manifold bushing or valve bushing when the valve stem is in the up or open position.

Leakage or weepage is so common that some devices in the prior art have leakage or weepage holes to direct leakage or weepage away from critical areas of the hot runner system. Unfortunately, utilizing leakage or weepage holes is not desirable and leakage or weepage holes can only accommodate a certain quantity of leakage or weepage.

Leakage or weepage causes a variety of problems in a hot runner system. Leakage or weepage may get into the cylinder actuating the valve stem causing performance problems. The cylinder has a number of moving parts, such as the piston, that may fail when introduced to leakage or weepage. Another problem is with leakage or weepage building up around the manifold. In that case, the hot runner system needs to be disassembled and reworked, which is labor intensive and a significant disadvantage. And still another problem with leakage or weepage is that the solidified plastic in the clearance area between the valve stem and the manifold bushing or valve bushing may result in valve stem seizing or galling.

There have been many attempts made in the prior art to produce valve gates that preclude leakage or weepage. United States Patent Application No. 20030072833 attempts to preclude leakage or weepage by utilizing a valve pin positioned in a melt channel. The valve stem is predominately used for controlling the flow of melt to the mold cavity. An arm is connected to the valve pin from outside of the melt channel in an attempt to preclude leakage. In addition, a mold plug surrounds the valve pin in an attempt to preclude leakage. The problem with this type of device is that the retrofit for an existing hot runner system is extensive. Moreover, new hot runner systems would need to be redesigned to accommodate the arm and mold plug. Also, the arm and mold plug must be manufactured with tight tolerance to effectively preclude leakage. This design is costly and complex.

United States Patent Application No. 20030086996 attempts to eliminate leakage or weepage with a bushing. Unfortunately, the valve stem must be movably mounted to the bushing, thus creating another area susceptible to leakage or weepage.

Similarly, U.S. Pat. No. 5,670,190 describes a valve stem movably mounted to a bushing so that the valve stem can be used to open and close the gate opening. The valve stem is driven vertically by a gear arrangement. Unfortunately, this type of arrangement utilizes a sealing bushing which creates another area susceptible to leakage or weepage.

United States Patent Application No. 200300118687 also describes a valve pin that moves through a bushing. Although the disclosure is directed to providing a guide body in the channel to better guide the melt, the bushing purports to provide a seal with the valve pin. Similar to the other devices in the prior art, this arrangement, and specifically the guide body, is also susceptible to leakage or weepage.

The present invention is directed to overcoming one or more of the problems and disadvantages set forth above, and for providing a valve stem having a reverse taper thereon for precluding stem leakage or weepage.

### SUMMARY OF THE INVENTION

The present invention is a valve stem having a reverse taper for sealing a clearance area between the valve stem and the valve bushing or manifold bushing, thereby precluding weepage in the hot runner system. The reverse taper has a diameter which is larger than an internal diameter of the internal passage of the valve bushing or manifold bushing.

The present invention also includes a headless valve stem having a reverse taper for sealing the clearance area between the valve stem and the valve bushing or manifold bushing, thereby precluding weepage in the hot runner system.

In one aspect of the invention, a valve stem is coaxially to and operatively mounted in at least a portion of an internal passage of a nozzle and internal passage of either a valve bushing or a manifold bushing in a hot runner system, the valve stem comprises a shaft movably mounted in the internal passages of the nozzle and either the valve bushing or the manifold bushing, a first end of the shaft, for plugging an opening in a mold cavity in a first position, and a reverse taper on the shaft, for sealing a clearance between the valve stem and either the valve bushing or the manifold bushing in a second position.

In another aspect of the invention, a headless valve stem is used in a nozzle of a hot runner system, the valve stem comprises a first end having a diameter, and for plugging an opening in a mold cavity tip when in a first position, a middle section having a bulbous portion, the bulbous portion having a diameter larger than the diameter of the first end for sealing a clearance between the headless valve stem and either a valve or manifold bushing, and a second end opposite said first end having a recess.

In yet another aspect of the invention, a valve stem is used in a nozzle of a hot runner system, the valve stem comprises a first end having a diameter, and for plugging an opening in a mold cavity in a first position, a middle portion having a diameter larger than the diameter of the first end for sealing a clearance between the valve stem and either a valve or manifold bushing, and a second end.

In still another aspect of the invention, a valve stem is used in an injection machine nozzle for a hot runner system, the valve stem comprises a first end having a diameter, and for plugging an opening in the injection machine nozzle when in a first position, and a middle section having a bulbous portion, the bulbous portion having a diameter larger than the diameter of the first end for sealing a clearance between the valve stem and the injection machine nozzle.

In still yet another aspect of the invention, a valve stem is used in a sprue bar in a hot runner system, the valve stem comprises a first end having a diameter, and for plugging an opening in the sprue bar when in a first position, and a middle section having a bulbous portion, the bulbous portion having a diameter larger than the diameter of the first end for sealing a clearance between the valve stem and the sprue bar.

In another aspect of the invention, a valve stem is coaxially to and operatively mounted in at least a portion of an internal passage of a nozzle and internal passage of a manifold in a hot runner system, the valve stem comprises a shaft movably mounted in the internal passages of the nozzle and the manifold, a first end of the shaft, for plugging an opening in a mold cavity in a first position, and a reverse taper on the shaft, for sealing a clearance between the valve stem and the manifold in a second position.

In yet another aspect of the invention, there is a bushing having an internal passage for receiving a valve stem having a reverse taper thereon in a hot runner system, the bushing comprises a face proximate the internal passage, the face having a complimentary portion for receiving the reverse taper, and wherein the reverse taper seals a clearance between the valve stem and the bushing when the reverse taper of the valve stem engages the face of the bushing.

In still another aspect of the invention, there is a manifold having an internal passage for receiving a valve stem having a reverse taper in a hot runner system, the manifold comprises a face proximate the internal passage, the face having a complimentary portion for receiving the reverse taper, and wherein the reverse taper seals a clearance between the valve stem and the internal passage of the manifold when the reverse taper of the valve stem engages the face of the manifold.

It is important to note that the present invention is not intended to be limited to an apparatus or device which must satisfy one or more of any stated feature or advantage of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the following appended claims.

### BRIEF DESCRIPTION OF THE DRAWINGS

These and other features and advantages of the present invention will be better understood by reading the following detailed description, taken together with the drawings wherein:

FIG. 1 is a cross-sectional view of a hot runner system having valve stems with reverse tapers thereon according to the present invention;

FIG. 2 is a cross-sectional view of the valve stem having the reverse taper thereon shown in FIG. 1 positioned in the closed or down position according to the present invention;

FIG. 3 is a cross-sectional view of the valve stem having the reverse taper thereon shown in FIG. 1 positioned in the opened or up position according to the present invention; and

FIG. 4 is an exploded view of the cylinder and valve stem assembly shown in FIG. 1 according to the present invention.

### DETAILED DESCRIPTION

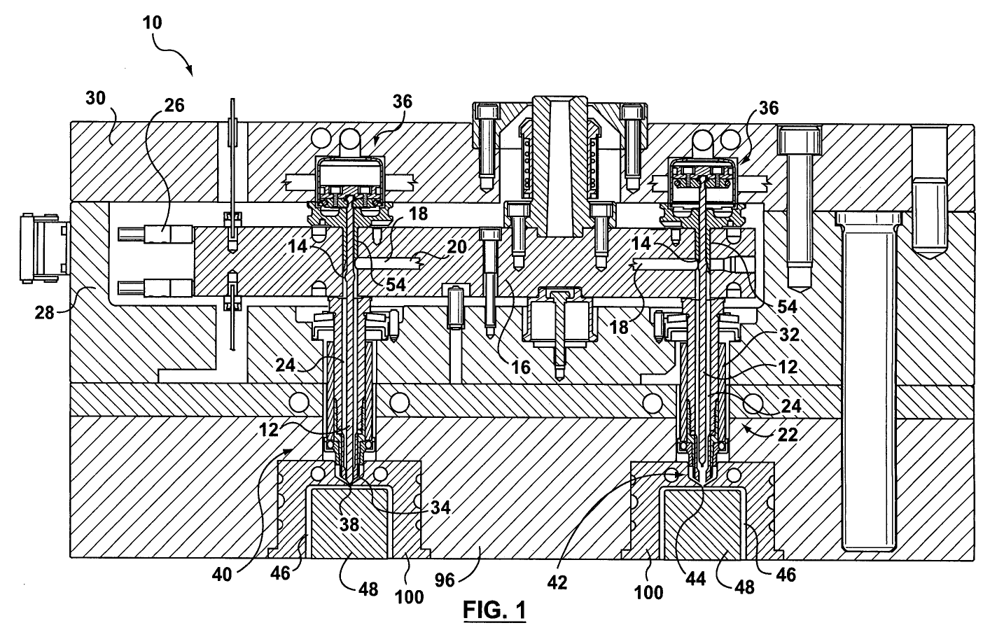

Referring now to the drawings and initially to FIG. 1, a hot runner system 10 having valve stems 12 with reverse tapers 14 thereon is shown in accordance with the present invention. The number of valve stems 12, etc. may be varied and is not meant to be limiting. The following description is not intended to describe each and every part of the hot runner system 10; rather, it describes the parts necessary to understand and practice the present invention.

The hot runner system 10 is used to transfer molten plastic from an injector (not shown) to at least one mold cavity 46 in a pair of cooperating mold plates 48, 100. The hot runner system 10 includes a manifold 16 having internal flow channels 18 for distributing molten plastic 20 to internal flow channels 24 of nozzles 22. The manifold 16 is operatively mounted between a manifold plate 28 and a backing plate 30. To maintain the molten plastic 20 in liquid form, the manifold 16 is heated by a manifold heater 26.

To maintain the molten plastic 20 in liquid form in the internal flow channels 24 of the nozzles 22, a nozzle heater 32 is operatively mounted to the nozzle 22. The nozzle 22 has internal flow channels 24 in fluid communication with the internal flow channels 18 of the manifold 16, and/or manifold bushing or valve bushing (hereinafter referred to as “valve bushing 54”). The nozzle 22 injects molten plastic through a nozzle tip 34 into the at least one mold cavity 46 in the mold plates 48, 100, thereby producing plastic parts when the plastic solidifies. In an alternative embodiment, the invention is practiced with a hot runner system 10 that does not have a valve bushing 54; rather, there is a bore through the manifold 16 and the nozzle 22 has internal flow channels 24 in fluid communication with the bore or internal flow channels 18 of the manifold 16. The nozzle 22 injects molten plastic through a nozzle tip 34 into the at least one mold cavity 46 in the mold plates 48, 100, thereby producing plastic parts when the plastic solidifies.

Cylinders 36 are used to actuate the valve stems 12 into an up or open position 42, and into a down or closed position 40. The transition to the down or closed position 40 includes termination of the injection pressure to the hot runner system 10 and downward movement of the valve stem 12 so that a valve stem tip 38 plugs or blocks an opening 44 in the gate. This precludes molten plastic from flowing from the internal flow channels 24 of the nozzle 22 in the hot runner system 10 to the at least one mold cavity 46 of the mold plates 48, 100. In the up or open position 42, injection pressure to the hot runner system 10 is initiated and the valve stem 12 is moved upward so that the valve stem tip 38 is removed from the opening 44: in the gate. This allows molten plastic to flow from the internal flow channels 24 of the nozzle 22 to the at least one mold cavity 34, thereby filling the at least one cavity 46.

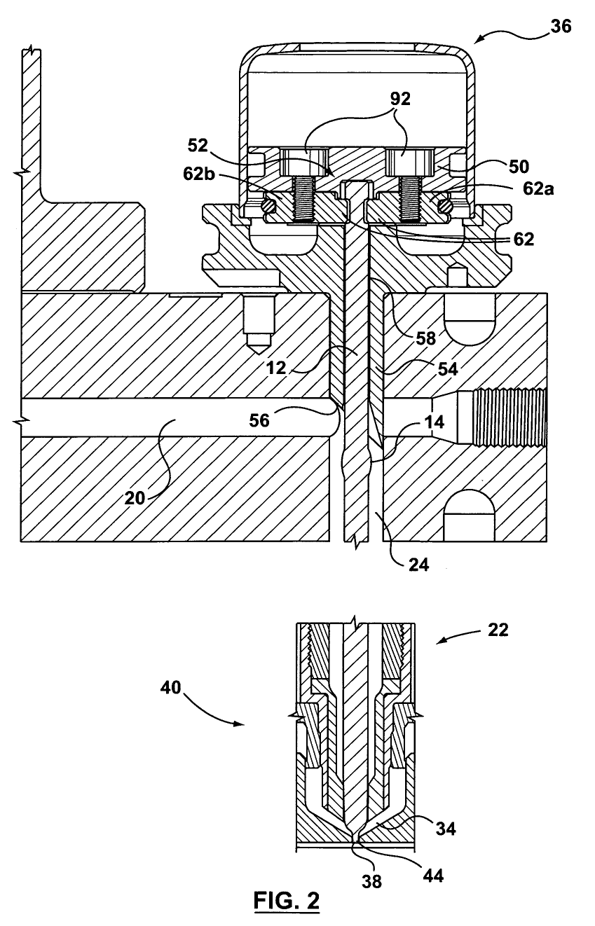

Turning now to FIG. 2, the valve stem 12 is shown in the down or closed position 40. In this position, the valve stem tip 38 blocks or plugs the opening 44 in the gate. At an opposite end 52 of the valve stem 12, the valve stem 12 is operatively attached to a piston 50 and spacer 62. The valve stem 12 extends from the cylinder 36 through an internal passage 58 in the valve bushing 54 then through the internal flow channel 18 of the valve bushing 54, if any, to the internal flow channel 24 of the nozzle 22 to the opening 44 in the nozzle tip 34. Because the valve stem 12 moves up and down in the valve bushing 54, there must be a clearance between the valve stem 12 and internal walls of the internal passage 58. However, this clearance must be minimal to reduce leakage or weepage. In the down or closed position 40, the reverse taper 14 does not engaged with a bottom surface 56 of the valve bushing 54.

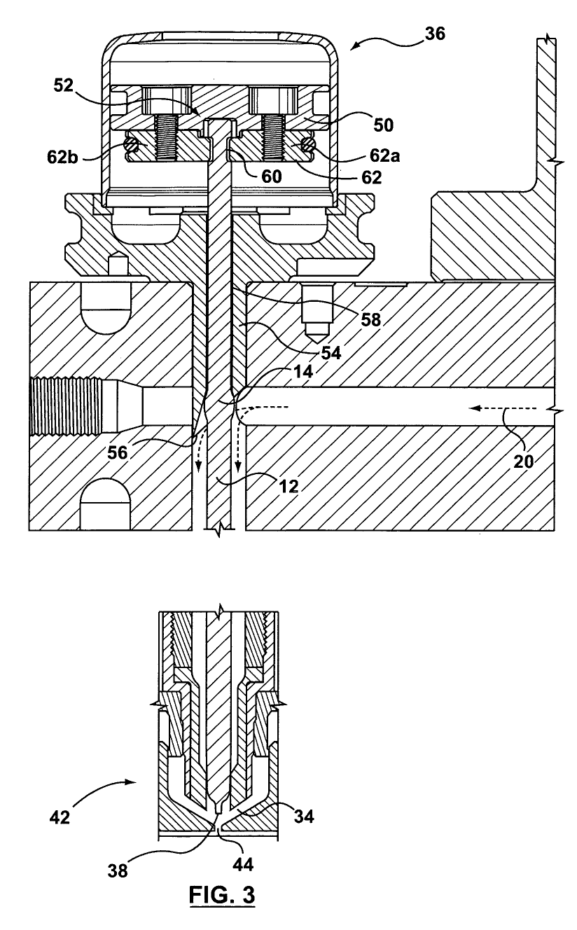

Turning now to FIG. 3, the valve stem 12 is shown in the up or open position 42. In this position, the valve stem tip 38 is not blocking or plugging the opening 44 in the gate, and the reverse taper 14 contacts or engages the bottom surface 56 of the valve bushing 54, thereby sealing or plugging the clearance between the valve stem 12 and the internal walls of the internal passage 58. In this up or open position 42, molten plastic flows through the hot runner system 10 and exits through the opening 44 in the gate into and filling the at least one mold cavity 46.

When the reverse taper 14 contacts or engages the bottom surface 56 of the valve bushing 54 in the up or open position 42, it mechanically seals off the clearance between the valve stem 14 and the internal walls of the internal passage 58: of the valve bushing 54. This precludes molten plastic from traveling through the clearance. In addition, the reverse taper 14 allows the possibility of loosening the tolerances of the valve stem 12 and the internal passage of the valve bushing 54.

In the preferred embodiment, the reverse taper 14 of the valve stem 12 has a diameter which is larger than a diameter of the valve stem 12. For example, in one embodiment the valve stem 12 has a 4.025 mm diameter and the reverse taper 14 has a 4.75 mm diameter, which is used in conjunction with the valve bushing 54 having an inside diameter of 4.035 mm. It is important to note that these dimensions are just examples of one embodiment and may be varied according to the application.

In an alternative embodiment, the reverse taper 14 has a bulbous shape. In another alternative embodiment, the reverse taper 14 has a convex shape. In yet another alternative embodiment, the reverse taper 14 is integral to the valve stem 12. In still another embodiment, the reverse taper 14 is not integral and is operatively mounted to the valve stem 12.

In the preferred embodiment, the valve stem 12 has a headless design at end 52. The headless design includes a recess 60 around the circumference of the valve stem 12. The spacer 62 having a first half 62a and a second half 62b is operatively mounted in the recess 60 of the valve stem 12. During actuation of the cylinder 36, the spacer 62 moves the valve stem 12 up and down as explained in more detail below.

The valve stem 12 having the reverse taper 14 may also be used in a single cavity valve gate arrangement or a front mounted valve gate arrangement. In other embodiments, the reverse taper 14 is used in a sprue bar, shut-off bushing, machine nozzle, or injection nozzle.

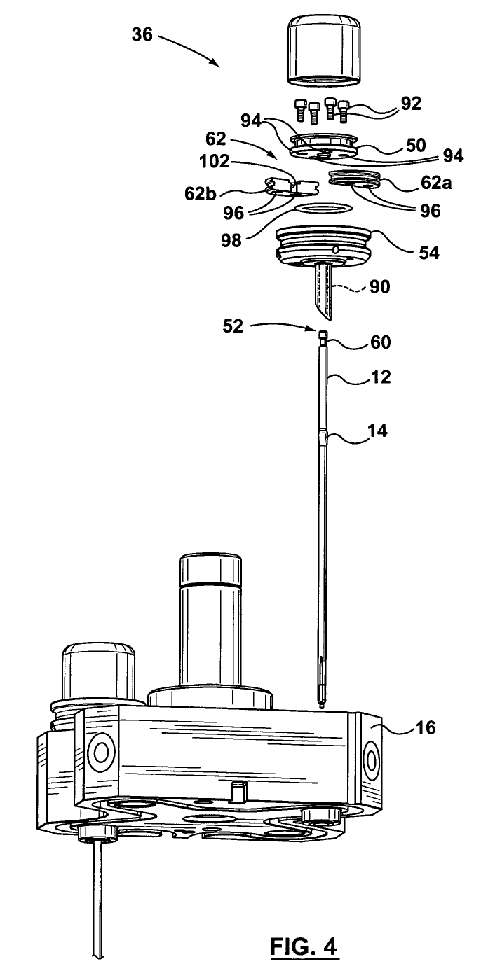

FIG. 4 illustrates the assembly of the headless valve stem 12 having the reverse taper 14 to the cylinder 36 in the hot runner system 10. To assemble the valve stem 12, the valve stem 12 is inserted through a center channel 90 in the valve bushing 54 and operatively mounted to the first half 62a and the second half 62b of the spacer 62. The valve stem 12 has a recess 60 to receive corresponding mating surfaces 102 in the first and second halves 62a, 62b of the spacer 62. A rubber gasket 98 is mounted around the circumference of the first and second halves 62a, 62b, thereby holding the corresponding mating surfaces 102 of the spacer 62 against the recess 60 in the valve stem 12. Screws 92 are inserted through holes 94 in the piston 50 and threaded into threaded holes 96 in the spacer 62, thereby holding the two halves 62a, 62b of the spacer 62 in the recess 60 of the valve stem 12 and operatively attaching the piston 52 to the spacer 62. In the preferred embodiment, four of the screws 92 are inserted through four of the holes 94 in the piston 50 and threaded into four of the threaded holes 96 in the spacer 62. Two of the screws 92 are assembled to the first half 62a of the spacer 62, and two of the screws 92 are assembled to the second half 62b of the spacer 62. During actuation of the cylinder 36, the valve stem 12 is moved up and down by the movement of the piston 50.

It is important to note that the present invention can be practiced with either the valve bushing 54 or the manifold bushing 54. Also, the valve bushing 54 or the manifold bushing 54 may or may not contain the internal passage 18 for which molten plastic 20 may pass to the internal flow channel 24 of the nozzle 22.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A valve stem coaxially to and operatively mounted in at least a portion of an internal passage of a nozzle and internal passage of either a valve bushing or a manifold bushing in a hot runner system, the valve stem comprising:
a shaft movably mounted in the internal passages of the nozzle and either the valve bushing or the manifold bushing;
a first end of the shaft, for plugging an opening in a mold cavity in a first position; and
a reverse taper on the shaft, for sealing a clearance between the valve stem and either the valve bushing or the manifold bushing in a second position.

2. The valve stem according to claim 1, wherein the valve stem is moved in a vertical direction between the first and second positions.

3. The valve stem according to claim 2, wherein when the valve stem is in the first position, the valve stem is moved downwardly.

4. The valve stem according to claim 2, wherein when the valve stem is in the second position, the valve stem is moved upwardly.

5. The valve stem according to claim 2, wherein the reverse taper is bulbous and engages a bottom surface of either the valve bushing or the manifold bushing.

6. The valve stem according to claim 5, wherein when the reverse taper of the valve stem engages the bottom surface of the valve bushing or the manifold bushing, the reverse taper plugs an end of the internal passage of the valve bushing or the manifold bushing.

7. The valve stem according to claim 6, wherein a diameter of the reverse taper is larger than the internal passage of the valve bushing or the manifold bushing.

8. A headless valve stem for use in a nozzle in a hot runner system, the valve stem comprising:
a first end having a diameter, and for plugging an opening in a mold cavity tip when in a first position;
a middle section having a bulbous portion, the bulbous portion having a diameter for sealing a clearance between the headless valve stem and either a valve or manifold bushing; and
a second end opposite said first end having a recess.

9. The headless valve stem according to claim 8, further including a spacer operatively mounted to the recess of the second end of the headless valve stem.

10. The headless valve stem according to claim 9, further including a piston operatively mounted to the spacer.

11. The headless valve stem according to claim 10, further including a cylinder for actuating the headless valve stem.

12. The headless valve stem according to claim 8, wherein the valve stem is displaceable downward into the first position such that the first end plugs the opening in the mold cavity precluding molten plastic from flowing from the nozzle tip.

13. The headless valve stem according to claim 12, wherein the valve stem is displaceable upward into a second position.

14. The headless valve stem according to claim 13, wherein the bulbous portion of the middle section engages a bottom surface of either the valve bushing or manifold bushing.

15. The headless valve stem according to claim 14, further including an internal passage in the valve bushing or manifold bushing, and wherein the valve stem is coaxial to and approximately parallel with the internal passage.

16. The headless valve stem according to claim 15, wherein when the middle section of the valve stem engages the bottom surface of the valve bushing or manifold bushing, the middle portion plugs an end of the internal passage.

17. A valve stem for use in a nozzle in a hot runner system, the valve stem comprising:
a first end having a diameter, and for plugging an opening in a mold cavity in a first position;
a middle portion having a diameter for sealing a clearance between the valve stem and either a valve or manifold bushing; and
a second end.

18. The valve stem according to claim 17, wherein the valve stem is displaceable downward into the first position precluding molten plastic from flowing from the nozzle tip.

19. The valve stem according to claim 18, wherein the valve stem is displaceable upward into a second position.

20. The valve stem according to claim 19, wherein the middle portion engages a bottom surface of either a valve bushing or manifold bushing.

21. The valve stem according to claim 20, further including an internal passage in the valve bushing or manifold bushing, and wherein the valve stem is coaxial and approximately parallel with the internal passage.

22. The valve stem according to claim 21, wherein when the middle portion of the valve stem engages the bottom surface of the valve bushing or manifold bushing, the middle portion plugs an end of the internal passage.

23. The valve stem according to claim 22, wherein the middle portion of the valve stem is convex shaped.

24. A valve stem for use in an injection machine nozzle in a hot runner system, the valve stem comprising:
a first end having a diameter, and for plugging an opening in the injection machine nozzle when in a first position; and
a middle section having a bulbous portion, the bulbous portion having a diameter for sealing a clearance between the valve stem and the injection machine nozzle.

25. A valve stem for use in a sprue bar in a hot runner system, the valve stem comprising:
a first end having a diameter, and for plugging an opening in the sprue bar when in a first position; and
a middle section having a bulbous portion, the bulbous portion having a diameter larger than the opening of the sprue bar for sealing a clearance between the valve stem and the sprue bar.

26. A valve stem coaxially to and operatively mounted in at least a portion of an internal passage of a nozzle and internal passage of a manifold in a hot runner system, the valve stem comprising:
a shaft movably mounted in the internal passages of the nozzle and the manifold;
a first end of the shaft, for plugging an opening in a mold cavity in a first position; and
a reverse taper on the shaft, for sealing a clearance between the valve stem and the manifold in a second position.

27. A bushing having an internal passage for receiving a valve stem having a reverse taper thereon in a hot runner system, the bushing comprising:
a face proximate the internal passage, the face having a complementary portion for receiving the reverse taper; and
wherein the reverse taper seals a clearance between the valve stem and the bushing when the reverse taper of the valve stem engages the face of the bushing.

28. A manifold having an internal passage for receiving a valve stem having a reverse taper in a hot runner system, the manifold comprising:
a face proximate the internal passage, the face having a complementary portion for receiving the reverse taper; and
wherein the reverse taper seals a clearance between the valve stem and the internal passage of the manifold when the reverse taper of the valve stem engages the face of the manifold.
